(19) United States
(12) Patent Application Publication
(10) Pub. No.: US 2023/0315532 A1
(43) Pub. Date: Oct. 5, 2023

(54) ALLOCATING COMPUTING RESOURCES BETWEEN MODEL SIZE AND TRAINING DATA DURING TRAINING OF A MACHINE LEARNING MODEL

(71) Applicant: DeepMind Technologies Limited, London (GB)

(72) Inventors: Jordan Hoffmann, London (GB); Sebastian Borgeaud Dit Avocat, London (GB); Laurent Sifre, Paris (FR); Arthur Mensch, Paris (FR)

(21) Appl. No.: 18/127,551

(22) Filed: Mar. 28, 2023

Related U.S. Application Data
(60) Provisional application No. 63/324,997, filed on Mar. 29, 2022.

(51) Int. Cl. G06F 9/50

(52) U.S. Cl. CPC G06F 9/505; G06F 9/5016; G06F 9/5044; G06F 2209/501; G06F 2209/5022; G06F 2209/506

(57) ABSTRACT

Methods, systems, and apparatus, including computer programs encoded on a computer storage medium, for training a machine learning model to perform a machine learning task. In one aspect, a method performed by one or more computer is described. The method includes: obtaining data defining a compute budget that characterizes an amount of computing resources allocated for training a machine learning model to perform a machine learning task; processing the data defining the compute budget using an allocation mapping, in accordance with a set of allocation mapping parameters, to generate an allocation tuple defining: (i) a target model size for the machine learning model, and (ii) a target amount of training data for training the machine learning model; instantiating the machine learning model, where the machine learning model has the target model size; and obtaining the target amount of training data for training the machine learning model.

### CROSS-REFERENCE TO RELATED APPLICATION

This application claims priority to U.S. Provisional Application No. 63/324,997, filed on Mar. 29, 2022. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a training system implemented as computer programs on one or more computers in one or more locations that can train a machine learning model to perform a machine learning task. As is described below, the training system can perform various methods and be realized in various systems to train the machine learning model.

In one aspect, a method performed by one or more computers for training a machine learning model is described. The method includes: obtaining data defining a compute budget that characterizes an amount of computing resources allocated for training the machine learning model to perform a machine learning task; and processing the data defining the compute budget using an allocation mapping, in accordance with a set of allocation mapping parameters, to generate an allocation tuple defining: (i) a target model size for the machine learning model, and (ii) a target amount of training data for training the machine learning model. According to the method, selecting a model size of the machine learning model as the target model size and training the machine learning model on the target amount of training data is predicted to optimize a performance of the machine learning model on the machine learning task subject to a constraint that an amount of computing resources used for training the machine learning model satisfies a threshold defined by the compute budget. The method further includes: instantiating the machine learning model, where the machine learning model has the target model size; obtaining the target amount of training data for training the machine learning model; and training the machine learning model having the target model size on the target amount of training data.

In some implementations, values of the set of allocation mapping parameters are determined by operations including: identifying multiple trial allocation tuples, where each trial allocation tuple defines: (i) a trial model size for the machine learning model, and (ii) a trial amount of training data for training the machine learning model; determining, for each of the multiple trial allocation tuples, a performance measure characterizing a performance of a trial machine learning model on the machine learning task resulting from selecting a model size of the trial machine learning model as the trial model size and training the trial machine learning model on the trial amount of training data; and determining the values of the set of allocation mapping parameters based on the performance measures corresponding to the plurality of trial allocation tuples.

In some implementations, determining the values of the set of allocation mapping parameters based on the performance measures corresponding to the plurality of trial allocation tuples includes: determining, for each of multiple compute budgets, an optimal model size and an optimal amount of training data corresponding to the compute budget based on the performance measures corresponding to the multiple trial allocation tuples; and determining the values of the set of allocation mapping parameters based on the optimal model size and the optimal amount of training data corresponding to each of the multiple compute budgets.

In some implementations, determining the values of the set of allocation mapping parameters based on the optimal model size and the optimal amount of training data corresponding to each of the multiple compute budgets includes: fitting the values of the set of allocation mapping parameters based on the optimal model size and the optimal amount of training data corresponding to each of the multiple compute budgets.

In some implementations, determining, for each of the multiple compute budgets, the optimal model size and the optimal amount of training data corresponding to the compute budget includes: determining a respective performance curve for each of multiple trial model sizes based on the performance measures corresponding to the multiple trial allocation tuples, where a performance curve for a trial model size defines a continuous mapping from possible compute budgets to predicted performance measures, and where a predicted performance measure corresponding to a possible compute budget defines a predicted performance of a trial machine learning model with the trial model size that is trained using an amount of computing resources that satisfies a threshold defined by the possible compute budget; and determining the optimal model size and the optimal amount of training data corresponding to each compute budget using the performance curves.

In some implementations, determining a performance curve for a trial model size includes: determining the performance curve for the trial model size by interpolating the performance measures of trial allocation tuples corresponding to the trial model size.

In some implementations, determining the optimal model size and the optimal amount of training data corresponding to each compute budget using the performance curves includes, for each compute budget of the multiple compute budgets: determining an optimal performance curve that achieves an optimal performance measure, from among the performance curves, for the compute budget; determining the optimal model size as the trial model size corresponding to the optimal performance curve; and determining the optimal amount of training data based on the compute budget and the optimal model size.

In some implementations, determining, for each of the multiple compute budgets, the optimal model size and the optimal amount of training data corresponding to the compute budget includes: determining a respective performance curve for each of the multiple compute budgets based on the performances measures corresponding to the multiple trial allocation tuples, where a performance curve for a compute budget defines a continuous mapping from possible model sizes to predicted performance measures, and where a predicted performance measure corresponding to a possible model size defines a predicted performance of a trial machine learning model with the possible model size that is trained using an amount of computing resources that satisfies a threshold defined by the compute budget; and determining the optimal model size and the optimal amount of training data corresponding to each compute budget using the performance curves.

In some implementations, determining a performance curve for a compute budget includes: determining the performance curve for the compute budget by interpolating performance measures of trial allocation tuples corresponding to the compute budget, where a trial allocation tuple corresponds to the compute budget if training a trial machine learning model with the trial model size defined by the trial allocation tuple on the trial amount of training data defined by the trial allocation tuple would use an amount of computing resources that satisfies a threshold defined by the compute budget.

In some implementations, determining the optimal model size and the optimal amount of training data corresponding to each compute budget using the performance curves includes, for each compute budget of the multiple compute budgets: determining the optimal model size as a model size that optimizes the performance curve corresponding to the compute budget; and determining the optimal amount of training data based on the compute budget and the optimal model size.

In some implementations, determining the values of the set of allocation mapping parameters based on the performance measures corresponding to the multiple trial allocation tuples includes: determining a set of parameters of a performance estimation function that is configured to process data defining: (i) an input model size, and (ii) an input amount of training data, to generate a predicted performance measure that characterizes a predicted performance of a machine learning model having the input model size, that is trained on the input amount of training data, on the machine learning task, including: fitting values of the set of parameters of the performance estimation function based on the performance measures corresponding to the plurality of trial allocation tuples; and determining the values of the set of allocation mapping parameters using the performance estimation function.

In some implementations, determining the values of the set of allocation mapping parameters using the performance estimation function includes: determining the values of the set of allocation mapping parameters to cause each input compute budget to be mapped to a target model size and a target amount of training data that optimize the performance estimation function subject to a constraint that training a machine learning model having the target model size on the target amount of training data uses an amount of computing resources given by the input compute budget.

In some implementations, fitting the values of the set of parameters of the performance estimation function based on the performance measures corresponding to the plurality of trial allocation tuples includes: fitting the values of the set of parameters of the performance estimation function to minimize, for each trial allocation tuple, a measure of error between: (i) the performance measure corresponding to the trial allocation tuple, and (ii) a predicted performance measure generated by processing the trial model size and the trial amount of training data defined by the trial allocation tuple using the performance estimation function.

In some implementations, the measure of error includes a Huber loss.

In some implementations, for each of the multiple trial allocation tuples, determining the performance measure corresponding to the trial allocation tuple includes: training a trial machine learning model having the trial model size on the trial amount of training data using a learning rate schedule that is selected based on the trial amount of training data.

In some implementations, the allocation mapping causes the target model size and the target amount of training data to increase at substantially a same rate in response to an increase in the compute budget.

In some implementations, the machine learning task includes a language modeling task.

In some implementations, the machine learning model includes a neural network model.

In some implementations, the method further includes: receiving a model input to the machine learning model; and processing the model input using the machine learning model, in accordance with trained values of a set of model parameters of the machine learning model, to generate a model output.

In some implementations, the machine learning model includes a multimodal model in which one or both of the model input and the model output include an image or audio, and the multimodal model is configured to process the model input that includes at least one of visual tokens representing pixels of a still or moving image, data representing an audio waveform, and textual tokens representing a sequence of text, to generate the model output that includes textual tokens, an image, or audio representing the model input.

In some implementations, the method is used for adapting the machine learning model to specific computing hardware, where the machine learning model includes a neural network model and the specific computing hardware includes multiple neural network accelerators. In this case, the method further includes: determining an energy budget for training the machine learning model, where the energy budget defines a total number of floating point operations for training the machine learning model; determining the compute budget from the energy budget; determining a hardware specification of the specific computing hardware on which the machine learning model is to be trained, where the hardware specification defines a number of the neural network accelerators in the specific computing hardware; using any of the abovementioned methods to determine the target model size for the machine learning model, where the target model size defines a number of trainable parameters of the machine learning model; using any of the abovementioned methods to determine the target amount of training data for training the machine learning model, where the target amount of training data defines a number of training tokens to be used for training the model; and training the machine learning model having the defined number of trainable parameters, on the specific computing hardware, using the defined number of training tokens.

In a second aspect, a method performed by one or more computers is described. The method includes: receiving a model input to a machine learning model; and processing the model input using the machine learning model, in accordance with trained values of a set of model parameters of the machine learning model, to generate a model output. In this case, the machine learning model has been generated by operations including: obtaining data defining a compute budget that characterizes an amount of computing resources allocated for training the machine learning model to perform a machine learning task; and processing the data defining the compute budget using an allocation mapping, in accordance with a set of allocation mapping parameters, to generate an allocation tuple defining: (i) a target model size for the machine learning model, and (ii) a target amount of training data for training the machine learning model. According to the method, selecting a model size of the machine learning model as the target model size and training the machine learning model on the target amount of training data is predicted to optimize a performance of the machine learning model on the machine learning task subject to a constraint that an amount of computing resources used for training the machine learning model satisfies a threshold defined by the compute budget. The method further includes: instantiating the machine learning model, where the machine learning model has the target model size; obtaining the target amount of training data for training the machine learning model; and training the machine learning model having the target model size on the target amount of training data.

In a third aspect, a system is described. The system includes one or more non-transitory computer storage media storing instructions that when executed by one or more computers cause the one or more computers to perform operations of any of the abovementioned methods.

In a fourth aspect, a system is described. The system includes one or more computers and one or more storage devices communicatively coupled to the one or more computers, where the one or more storage devices store instructions that, when executed by the one or more computers, cause the one or more computers to perform operations of any of the abovementioned methods.

As mentioned above, a training system can train a machine learning model to perform a machine learning task, e.g., by implementing any of the abovementioned methods. The machine learning model can be any appropriate type of machine learning model. For example, the machine learning model can be a neural network model, a random forest model, a support vector machine model, or any combination thereof, or any other type of machine learning model.

The machine learning model can have any appropriate machine learning model architecture. For instance, if the machine learning model is a neural network model, then the neural network model can have an attention-based neural network architecture (e.g., a transformer architecture), a convolutional architecture, a fully-connected architecture, or any other appropriate neural network architecture. In particular, the neural network model can include any appropriate types of neural network layers (e.g., convolutional layers, attention layers, fully connected layers, recurrent layers, etc.) in any appropriate numbers (e.g., 10 layers, 100 layers, or 1000 layers) and connected in any appropriate configuration (e.g., as a linear sequence of layers or as a directed graph of layers).

Throughout this specification, the “model size” of a machine learning model can refer to the number of (trainable) parameters required to implement the machine learning model, such as weights, biases, matrix elements, and so forth.

Throughout this specification, a “compute budget” characterizes an amount of computing resources allocated for training the machine learning model to perform the machine learning task. The compute budget can be measured in floating point operations (FLOPs), i.e., a total number of operations available to train the machine learning model. Note, FLOPs denoted with a lower case “s” is not be confused with floating point operations per second (FLOPS) which is denoted with an upper case “S” and corresponds to a rate of operations that can be performed by specific computing hardware. In some cases, the FLOPs can be determined from the FLOPS multiplied by the total computation time as FLOPs=FLOPS×time.

In some implementations, the method is used for adapting the machine learning model to specific computing hardware. In such cases, the machine learning model includes a neural network model and the specific computing hardware includes multiple neural network accelerators. A neural network accelerator is specialized hardware that is used to accelerate neural network computations, such as a GPU (Graphics Processing Unit) or TPU (Tensor Processing Unit). In general, a neural network accelerator is configured to perform hardware matrix multiplications, e.g., using parallel computations (e.g., it can include a set of one or more multiply accumulate units (MACs)).

The method can include determining an energy budget for training the machine learning model, where the energy budget defines a total available number of floating point operations for training the machine learning model. The energy budget may be determined according to a target carbon footprint for the training. The compute budget can be determined from the energy budget. Depending on how the energy budget is expressed, e.g., on the units in which it is expressed, the energy budget and the compute budget may both be defined as a total available number of floating point operations (FLOPs). Alternatively, the compute budget may be determined from an energy budget expressed in terms of electrical energy based upon a known (e.g., average) energy usage of the computing hardware. In some implementations, a majority (e.g., almost all) of the floating point operations (FLOPs) performed during the training are performed by the neural network accelerators, and thus the energy budget may be approximated on this assumption, e.g., using the energy consumption of a floating point operation on one of the neural network accelerators to determine the compute budget.

The method can be used to determine a hardware specification of the specific computing hardware on which the machine learning model is to be trained—the hardware specification defining a number of neural network accelerators included in the specific computing hardware. The method is then used to determine the target model size for the machine learning model, the target model size defining a number of trainable parameters of the machine learning model. The method is also used to determine the target amount of training data for training the machine learning model, the target amount of training data defining a number of training data items, in particular, training tokens to be used for training the model. As described later, such training tokens represent training data items, such as textual tokens representing words or wordpieces, or visual tokens representing intensity values for pixels of a still or moving image, e.g., for a region of the image. The method trains a machine learning model, i.e., the neural network with the defined number of trainable parameters, on the specific computing hardware using the defined number of training tokens. It has been found that, for a given energy and compute budget, many neural network models are far too large and are trained with too few tokens, indicating that some previously held assumptions about machine learning models are incorrect. That is, a general trend to increase model size has been found to result in models that are effectively underperforming and, surprisingly, it has been found that constraining a model to fit within specific hardware constraints, and applying the techniques described herein, can result in substantially better performance than was expected hitherto. Some results supporting the described techniques are presented later.

The machine learning model used for the techniques described herein can be configured to perform any appropriate machine learning task.

In particular, the machine learning model can be configured to process any appropriate model input, e.g., including one or more of: an image, an audio waveform, a point cloud (e.g., generated by a lidar or radar sensor), a representation of a protein, a representation of a molecule, a sequence of words (e.g., that form one or more sentences or paragraphs), a video (e.g., represented a sequence of video frames), or a combination thereof.

The machine learning model can be configured to generate any model output that characterizes the model input. For example, the model output can be a classification output, a regression output, a sequence output (i.e., that includes a sequence of output elements), a segmentation output, or a combination thereof.

A few examples of machine learning tasks that can be performed by the machine learning model are described in more detail next.

In some implementations, the machine learning model is configured to process a model input that represents the pixels of an image to generate a classification output that includes a respective score for each object category in a set of possible object categories (e.g., vehicle, pedestrian, bicyclist, etc.). The score for an object category can define a likelihood that the image depicts an object that belongs to the object category.

In some implementations, the machine learning model is configured to process a model input that represents audio samples in an audio waveform to perform speech recognition, i.e., to generate an output that defines a sequence of phonemes, graphemes, characters, or words corresponding to the audio waveform.

In some implementations, the machine learning model is configured to process a model input that represent words in a sequence of words to perform a natural language processing task, e.g., topic classification or summarization. To perform topic classification, the machine learning model generates an output that includes a respective score for each topic category in a set of possible category categories (e.g., sports, business, science, etc.). The score for a topic category can define a likelihood that the sequence of words pertains to the topic category. To perform summarization, the machine learning model generates an output that includes an output sequence of words that has a shorter length than the input sequence of words and that captures important or relevant information from the input sequence of words.

In some implementations, the machine learning model performs a machine translation task, e.g., by processing a model input that represents a sequence of text such as a sequence of words, phrases, characters, or word pieces, in one language, to generate an output that can be a translation of the sequence of text into another language, i.e., a sequence of text in the other language that is a translation of the input sequence of text. As a particular example, the task can be a multi-lingual machine translation task, where the machine learning model is configured to translate between multiple different source language—target language pairs. In this example, the source language text can be augmented with an identifier that indicates the target language into which the machine learning model should translate the source language text.

In some implementations, the machine learning model is configured to perform an audio processing task. For example, if the model input represents a spoken utterance, then the output generated by the machine learning model can be a score for each of a set of pieces of text, each score representing an estimated likelihood that the piece of text is the correct transcript for the utterance. As another example, if the model input represents a spoken utterance, the output generated by the machine learning model can indicate whether a particular word or phrase (“hotword”) was spoken in the utterance. As another example, if the model input represents a spoken utterance, the output generated by the machine learning model can identify the natural language in which the utterance was spoken.

In some implementations, the machine learning model is configured to perform a natural language processing or understanding task, e.g., an entailment task, a paraphrase task, a textual similarity task, a sentiment task, a sentence completion task, a grammaticality task, and so on, that operates on a set of model inputs representing text in some natural language.

In some implementations, the machine learning model is configured to perform a text to speech task, where the model input represents text in a natural language or features of text in a natural language and the model output is a spectrogram, a waveform, or other data defining audio of the text being spoken in the natural language.

In some implementations, the machine learning model is configured to perform a text generation task, where the model input represents a sequence of text, and the output is another sequence of text, e.g., a completion of the input sequence of text, a response to a question posed in the input sequence, or a sequence of text that is about a topic specified by the first sequence of text. As another example, the model input can represent data other than text, e.g., an image, and the output sequence can be text that describes the data represented by the model inputs.

In some implementations, the machine learning model is configured to perform an image generation task, where the model input represent a conditioning input and the output is a sequence of intensity value inputs for the pixels of an image.

In some implementations, the machine learning model is configured to perform an agent control task, where the model input represents a sequence of one or more observations or other data characterizing states of an environment and the output defines an action to be performed by the agent in response to the most recent data in the sequence. The agent may be a mechanical agent acting in a real-world environment to perform a task; the observations may include any type of observations, e.g., image observations; the model output may include control signals to control the agent to perform the task. Optionally, the model input may include other information, e.g., textual tokens for text defining the task to be performed. The agent can be a real-world or simulated robot, a control system for an industrial facility, or a control system that controls a different kind of agent.

In some implementations, the machine learning model is configured to perform a genomics task, where the model input represents a fragment of a DNA sequence or other molecule sequence and the output includes, e.g., a promoter site prediction, a methylation analysis, a prediction for functional effects of non-coding variants, and so on.

In some implementations, the machine learning model is configured to perform a protein modeling task, e.g., where the model input represents a protein and the model output characterizes the protein. For example, the model output can characterize a predicted stability of the protein or a predicted structure of the protein.

In some implementations, the machine learning model is configured to perform a point cloud processing task, e.g., where the model input represents a point cloud (e.g., generated by a lidar or radar sensor) and the model output characterizes, e.g., a type of object represented by the point cloud.

In some implementations, the machine learning model is configured to perform a language modeling task, e.g., by autoregressively generating an output sequence of textual data. More specifically, the machine learning model can be configured to generate a sequence of output textual tokens (where the textual tokens can include, e.g., characters, word pieces, words, n-grams, etc.). The machine learning model can generate the output sequence of textual tokens over a sequence of time steps. At each time step, the machine learning model can generate the output token at a respective position in the sequence of output textual tokens. The machine learning model can condition the generation of the textual token at a position in the output sequence on textual tokens generated for each of one or more preceding positions in the output sequence. For instance, to generate a textual token at a position in the output sequence of textual tokens, the machine learning model can process data including textual tokens generated for one or more preceding positions in the output sequence of textual tokens to generate a score distribution over a set of possible textual tokens. The machine learning model can then select a token for the position using the score distribution, e.g., by selecting a token having a highest score under the score distribution.

Optionally, a machine learning model configured to perform a language modeling task can be conditioned using one or more conditioning inputs. For example, the machine learning model can be conditioned on a question, and the machine learning model can autoregressively generate an output sequence of textual data that provides an answer to the question. As another example, the machine learning model can be conditioned on a task and a programming language, and the machine learning model can autoregressively generate an output sequence of textual data defining instructions in the programming language to accomplish the task. As another example, the machine learning model can be conditioned on a set of input instructions, e.g., textual instructions, and the machine learning model can autoregressively generate an output sequence of textual data that is responsive to the set of input instructions.

In some cases, a machine learning model configured to perform a language modeling task can be implemented as a neural network model. The neural network model can include attention neural network layers, e.g., self-attention neural network layers, cross-attention neural network layers, or both.

In some implementations, the machine learning model is configured to perform a combination of multiple individual machine learning tasks, e.g., two or more of the machine learning tasks mentioned above. For example, the machine learning model can be configured to perform multiple individual natural language understanding tasks, with the model inputs processed by the machine learning model including an identifier for the individual natural language understanding task to be performed on model input.

As a particular example, the machine learning model can include a multimodal model in which one or both of the model input and the model output include an image or audio. For instance, the multimodal machine learning model may be configured to process a model input including visual tokens representing pixels of a still or moving image (e.g., a point cloud image) and/or data representing an audio waveform (e.g., values or features of the audio waveform such as audio tokens and/or text tokens representing a sequence of text) to generate a model output (e.g., text tokens representing the still or moving image or audio waveform and/or a sequence of intensity value inputs for pixels of an image or a sequence of values defining an audio waveform). A visual token may represent multiple pixels in a region of the image, e.g., as features of the region. Such a multimodal model may perform any of the previously described tasks using a multimodal input, or by providing a multimodal output, or by converting between different input and output modes (e.g., text/image/audio). For example, the multimodal model may generate text representing, describing (e.g., captioning), or otherwise characterizing an image or audio input, e.g., by answering a question related to the image or audio input such as a physical prediction of a state of objects represented by the image or audio. As another example, the multimodal model may generate an image or audio represented, described, or otherwise characterized by a text input, or otherwise in response to the text input, e.g., representing an image or audio answer to a text question.

Throughout this specification, the term “optimize” can refer to predicted optimization or approximate optimization, i.e., rather than exact optimization.

Throughout this specification, a “performance measure” of a machine learning model on a machine learning task can refer to a measure of how effectively the machine learning model performs the machine learning task. For instance, the system described in this specification can measure the performance of a machine learning model using a loss or objective function, e.g., that characterizes a prediction accuracy of the machine learning model. That is, the performance measure may be represented as a value of a loss or objective function used to train the machine learning model. The system can measure the performance of a machine learning model, e.g., on a set of training data used for training the machine learning model, or on a set of validation data that is held out from the training of the machine learning model, i.e., such that the machine learning model is not trained on the set of validation data. Examples of loss/objective functions can include, e.g., cross-entropy objective functions, squared-error objective functions, etc.

For example, determining an optimal model size and an optimal amount of training data for a given compute budget can involve determining an optimization of each that optimizes a performance measure, e.g., that optimizes a value of an objective function used to train the machine learning model or that minimizes a value of a loss function used to train the machine learning model.

The subject matter described in this specification can be implemented in particular embodiments so as to realize one or more of the following advantages.

The training system described in this specification trains a machine learning model to perform a machine learning task subject to a compute budget that allocates a limited amount of computing resources (e.g., FLOPs) for training the machine learning model. Training the machine learning model subject to the compute budget involves a tradeoff between: (i) the model size of the machine learning model, and (ii) the amount of training data used for training the machine learning model. For instance, increasing the model size of the machine learning model can require a reduction in the amount of training data that can be used for training the machine learning model, i.e., to ensure that the computational resources consumed during training do not exceed the compute budget. To be precise, the amount of training data used for training the machine learning model generally refers to the amount of training data seen by the machine learning model during training, and not necessarily the total amount of training data at the training system's disposal. For example, if there is a limited amount of training data available for a particular machine learning model and/or a particular machine learning task, training system can sample multiple times (if necessary) from the available training data. In this case, the amount of training data used for training the machine learning model may include multiple instances of the same data (e.g., tokens).

The training system determines the tradeoff between the model size of the machine learning model and the amount of training data used for training the machine learning model using an allocation mapping. In particular, the allocation mapping processes data defining the compute budget to generate data defining a target model size and a target amount of training data which are predicted to optimize the performance of the machine learning model subject to the constraint defined by the compute budget. That is, the training system uses the allocation mapping to determine an allocation of computing resources between model size and training data in order to optimize the performance (e.g., prediction accuracy) of the machine learning model.

A trial system can determine the mapping parameters of the allocation mapping by training a range of trial machine learning models, varying the model size, the amount of training data used for training, and the available computational resources designated by compute budgets, to determine empirical data of the various trial machine learning models. An optimization system can then use the resulting data characterizing performance of the machine learning model across model sizes, amounts of training data, and compute budgets to fit the parameters of the allocation mapping. For example, the optimization system can interpolate (as well as extrapolate) the data to different compute budgets while simultaneously determining the optimal model size and optimal amount of training data for the compute budgets. After determining the parameters of the allocation mapping, the training system can thereafter use the allocation mapping to determine an optimal tradeoff between model size and amount of training data each time the training system trains a machine learning model to perform a machine learning task.

By optimally allocating computing resources between model size and amount of training data, the training system can significantly increase efficiency in usage of computational resources during training. For instance, the training system can reduce the likelihood of computing resources being wasted by overtraining a machine learning model, i.e., by training the machine learning model on a set of training data beyond a point where no further gains in the performance of the machine learning model are achieved. As another example, the training system can select a model size for the machine learning model that is significantly smaller than would otherwise have been selected (for the same set of training data), thereby reducing use of computational resources during fine-tuning and downstream use of the trained machine learning model.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system that can train a machine learning model having a target model size on a target amount of training data to perform a machine learning task.

FIG. 2 is a flow diagram of an example process for training a machine learning model having a target model size on a target amount of training data to perform a machine learning task.

FIG. 3 is a block diagram of an example trial system that can determine values of a set of allocation mapping parameters based on performance measures of trial machine learning models.

FIG. 4 is a flow diagram of an example process for determining values of a set of allocation mapping parameters based on performance measures of trial machine learning models.

FIG. 5 is a block diagram of two example optimization systems that can determine values of a set of allocation mapping parameters based on performance curves.

FIG. 6 is a flow diagram of an example process for determining values of a set of allocation mapping parameters based on optimal model sizes and optimal amounts of training data for given compute budgets.

FIG. 7A is a flow diagram of an example process for determining optimal model sizes and optimal amounts of training data for given compute budgets based on performance curves.

FIG. 7B shows an example of generating a set of allocation mapping parameters using performance curves that define a continuous mapping from possible compute budgets to predicted performance measures.

FIG. 8A is a flow diagram of another example process for determining optimal model sizes and optimal amounts of training data for given compute budgets based on performance curves.

FIG. 8B shows an example of generating a set of allocation mapping parameters using a respective performance curve for each of multiple possible compute budgets.

FIGS. 9A and 9B are block diagrams of another example optimization system that can determine values of a set of allocation mapping parameters using a performance estimation function.

FIG. 10 is a flow diagram of an example process for determining values of a set of allocation mapping parameters using a performance estimation function.

FIGS. 11A and 11B show examples of experimental results that compare the performance of: (i) a “compute-optimal” machine learning model that is generated by the training system described in this specification, and (ii) an alternative machine learning model.

Like reference numbers and designations in the various drawings indicate like elements.

### DETAILED DESCRIPTION

Large machine learning models such as large language models (e.g., machine learning models including neural networks that perform language modeling tasks as described above), deep learning models, generative models, discriminative and classification models, regression models, and others, have been implemented with large numbers of parameters, e.g., more than 10 billion parameters, or more than 50 billion parameters, or more than 100 billion parameters, or more than 250 billion parameters, or more than 500 billion parameters. Large language models (LLMs) in particular have demonstrated impressive performance on many machine learning tasks (e.g., language modeling tasks) using a variety of training and evaluation protocols including zero-shot, few-shot, and fine-tuning.

However, the computational and energy costs for training large machine learning models (e.g., LLMs) are substantial and can rise with increasing model size. In practice, the allocated training compute (i.e., a compute budget) may be known in advance, e.g., how many accelerators (e.g., high performance computational units) are available and for how long the accelerators are available. In some situations, it may only be feasible to train a machine learning model once (or a small number of times), thus accurately estimating the best model hyper-parameters for a given compute budget can be considerably valuable. For instance, reducing the model size of a machine learning model can reduce inference costs considerably and facilitate downstream implementation in resource constrained environments. The energy cost of a large machine learning model is amortized through its usage for inference and fine-tuning. The benefits of a more optimally trained smaller model, therefore, extend beyond the immediate benefits of its improved performance.

In this regard, the training system described herein can predict the target model size and the target amount of training data in a manner that is predicted to (approximately) optimize performance of a machine learning model for a given compute budget, i.e., such that training the machine learning model is compute-optimal. In some cases, the training system can determine that training a compute-optimal machine learning model on a given compute budget can require substantially increasing the volume of training data, e.g., as opposed to increasing the model size. For example, for some compute-optimal machine learning models (e.g., LLMs), the training system can determine that model sizes and training data sizes are scaled in (approximately) equal proportions to compute budgets.

Moreover, as delineated in this specification, large machine learning models may not need to be trained to their lowest possible loss to be compute-optimal. That is, the described techniques describe how to optimize a loss for a given compute budget, taking into account that the machine learning model may not be trained to convergence. For example, as described later, some implementations of the system use a performance estimation function that take account of this, e.g., that includes a term that represents a residual part of the loss due to the machine learning model not being trained to convergence.

For reference, some LLMs include a transformer neural network, i.e., a neural network model with a transformer architecture. In general, a transformer neural network may be a neural network model characterized by having a succession of self-attention neural network layers. A self-attention neural network layer has an attention layer input for each element of the input and is configured to apply an attention mechanism over the attention layer input to generate an attention layer output for each element of the input. There are many different attention mechanisms that may be used. Some of these LLMs may use a transformer neural network as an encoder, some may use a transformer neural network as a decoder, while some may use one transformer neural network as an encoder and another as a decoder, coupled to the encoder. Merely as an example, some LLMs are decoder-only models.

These features and other features are described in more detail below.

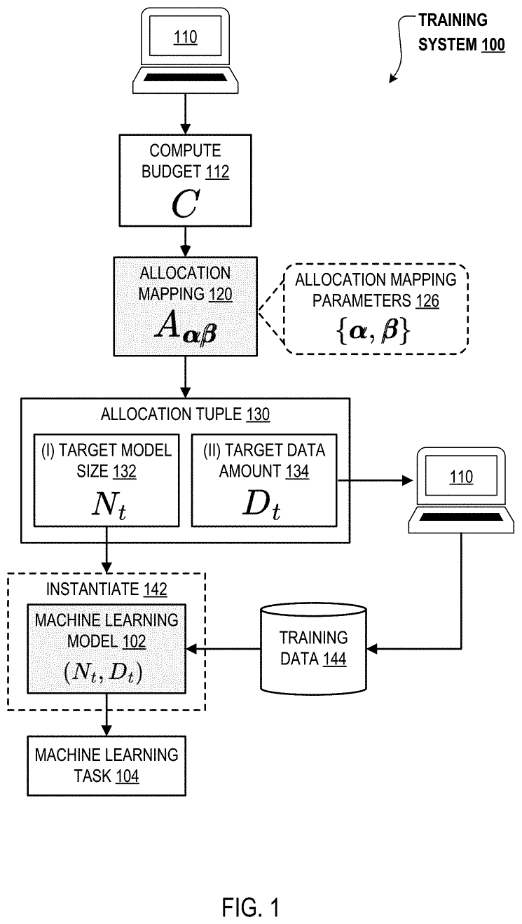

FIG. 1 shows an example training system 100 that can train a machine learning model 102 having a target model size 132 on a target amount of training data 134 to perform a machine learning task 104. The training system 100 is an example of a system implemented as computer programs on one or more computers in one or more locations in which the systems, components, and techniques described below are implemented.

In general, for any particular machine learning model 102 that is configured to perform any particular machine learning task 104, the training system 100 is capable of selecting a target model size Nₜ 132 and a target amount of training data Dt 134 that are predicted to be compute-optimal. In other words, the target sizes 132 and 134 are predicted to optimize a (predicted) performance of the model 102 on the task 104, subject to a constraint that an amount of computing resources used for training (F) satisfies a threshold defined by a compute budget C 112, e.g., such that F=C, or such that F≤C. The compute budget 112 defines the amount of computing resources allocated for training. For example, the allocated computing resources may be fixed due to an available computing architecture (e.g., a number of accelerators, servers, GPU clusters, supercomputers, combinations thereof, etc.) and may not (or should not) be exceeded. Alternatively or in addition, the amount of allocated resources may be fixed to limit the energy expenditures associated with training the machine learning model 102, e.g., to reduce environmental impact, to allow multiple machine learning models to be training in parallel, etc. In any case, the training system 100 can enable a reduction in the volume of both computing and energy resources expended on training the machine learning model 102, while simultaneously enabling the machine learning model to achieve an acceptable performance on the machine learning task 104.

For reference, a model size N can refer to a number of parameters that can be employed by the machine learning model 102, e.g., that are required to implement the machine learning model 102. An amount of training data D, or a training data size, can refer to a particular size of a particular training data set 144 that can be used to train the machine learning model 102. For example, a training data size may refer to a number of tokens included in the training data set 144. More precisely, the amount of training data D used for training the machine learning model 102 refers to the amount of training data seen by the machine learning model 102 during training. Hence, a training data set 144 may include multiple instances of the same tokens if the total training data available to training system 100 is limited. As mentioned above, a compute budget 112 can refer to a quantity of computing resources allocated for training the machine learning model 102 and can be measured in a total number of floating point operations (FLOPs). In some cases, the compute budget 112 may also be measured in a total number of instructions, total computation time, memory space, or combinations thereof (e.g., as a weighted sum). The quantity of computing resources used during training F (also referred to as the total compute) can be measured in the same units as the compute budget 112.

To determine the target sizes 132 and 134 for a machine learning model 102, training system 100 first obtains (e.g., receives) data defining the compute budget 112. For example, the data can be provided to the training system 100 by a user or an automated process seeking to perform a compute-optimal training regime on the machine learning model 102 under the compute budget 112. For ease of description, data defining the compute budget 102 may be described as being provided by a server 110, e.g., a cloud server, a local server, or a remote server, etc.

Training system 110 processes the data defining the compute budget 112 using an allocation mapping A_{αβ} 120 to generate an allocation tuple [Nₜ, Dₜ] 130. The allocation tuple 130 is a 2-tuple that defines the target model size Nₜ 132 and the target data size Dₜ 134. In general, the allocation mapping A_{αβ} 120 a function parametrized by a set of allocation mapping parameters {α, β} 126. The mapping parameters 126 dictate how that allocation mapping 120 determines a compute-optimal allocation of the compute budget C between possible model sizes N and possible data sizes D. As mentioned above, the compute-optimal allocation corresponds to the selection of the target sizes Nₜ and Dₜ as the model and data sizes:

[Nₜ(C),Dₜ(C)]=A_{αβ}(C)

For clarity, α={α₀, α₁, . . . , αₙ} and β={β₀, β₁, . . . , βₙ} are subsets of the set of mapping parameters 126 that dictate how the allocation mapping A_{αβ} 120 continuously maps the compute budget C to the target model size Nₜ and the target data size Dₜ, respectively. The subsets α and β may share common parameters and do not necessarily have the same number of parameters. In general, the allocation mapping 120 can assume any functional form based on the particular set of mapping parameters 126. A few examples are described below.

In some implementations, the allocation mapping 120 may be represented as a linear function such that the mapping parameters 126 are slopes and intercepts, for example:

[Nₜ(C),Dₜ(C)]=[α₀,β₀]+[α₁,β₁]C

In some implementations, the allocation mapping 120 may be represented as a power law such that the mapping parameters 126 are coefficients and exponents, for example:

[Nₜ(C),Dₜ(C)]=[α₀C^{α}^{₁},β⁰C^{β}^{₁}]

In this case, when the machine learning system 102 is a LLM, the training system 100 may determine that, in some scenarios, α₁≈β₁≈0.5 characterizes the compute-optimal scaling of model size and data size with compute budget. That is, in these cases, the target model size 132 and target data size 134 should scale at substantially equal proportions to the compute budget 112.

In some implementations, the allocation mapping 120 may be represented as a polynomial or Taylor series of a certain order n such that the mapping parameters 126 are coefficients of polynomials, for example:

$$[ {N}_{t} ( C ) , {D}_{t} ( C ) ] = [ {α}_{0} , {β}_{0} ] + [ {α}_{1} , {β}_{1} ] C + … + [ {α}_{n} , {β}_{n} ] {C}^{n} = {\sum }_{q = 0}^{n} [ {α}_{q} , {β}_{q} ] {C}^{q}$$

More generally, in some implementations, the allocation mapping 120 may be represented as a set of basis of functions (e.g., of order n) such that the mapping parameters 126 are coefficients of basis functions, for example:

$$[ {N}_{t} ( C ) , {D}_{t} ( C ) ] = {\sum }_{q = 0}^{n} [ {α}_{q} , {β}_{q} ] {f}_{n , q} ( C )$$

The basis functions ƒ_{n,q}(C) can be polynomial basis functions, Lagrange basis functions, B-spline basis functions, Fourier basis functions, exponential basis functions, or any suitable set of basis functions of a desired order. In some cases, the basis functions themselves may also depend on the allocation mapping parameters 126.

The values of the mapping parameters 126 determine the precise functional dependence of the allocation mapping 120 on the compute budget 112. In particular, training system 100 uses values such that the selected target sizes Nₜ and Dₜ optimize the performance L(N,D) of the machine learning model 102 on the machine learning task 104, subject to the constraint that the total compute F(N,D) equals the compute budget C. In other words:

$${N}_{t} ( C ) , {D}_{t} ( C ) = {arg min L ( N , D )}_{N , D s . t . F ( N , D ) = C}$$

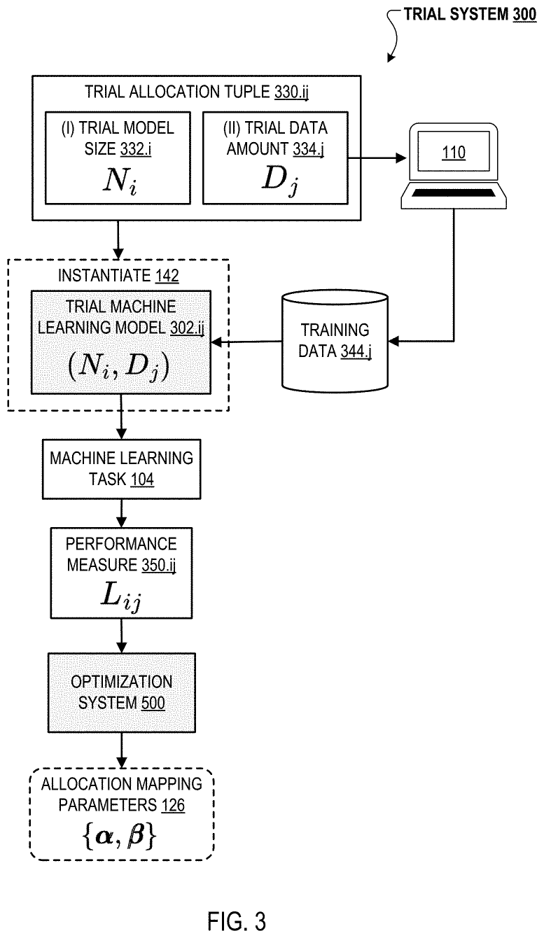

The above equation states that a machine learning model 102 associated with the allocation tuple [Nₜ, Dₜ] 130 consumes all of the compute budget 112 during training F(Nₜ, Dₜ)=C, while simultaneously optimizing its performance on the machine learning task 104 after training. For reference, the compute function F(N,D) represents the total compute used to train a machine learning model 102 having a particular model size N on a particular amount of training data D. The performance function L(N,D) represents a performance measure (e.g., a pre-training loss) of the machine learning model 102 on the machine learning task 104, given the particular sizes N and D of the model 102. Note, the precise functional dependencies of the compute function F(N,D) and the performance function L(N,D) are generally not known apriori since they depend on the sizes N and D of a particular machine learning model 102, which characterize its overall architecture (e.g., “global” properties). Consequently, determining an appropriate allocation mapping 120 that satisfies the above constraints is a challenging problem. Various systems and methods for determining (e.g., empirically estimating) the allocation mapping 120 are described in detail with respect to FIGS. 3-10.

After generating the allocation tuple 130, training system 100 instantiates 142 the machine learning model 102 with the target model size 132. Training system 100 then trains the machine learning model 102 on a training data set 144 having the target amount of training data 134. For example, training system 100 can obtain the training data set 144 from the server 110 or other means. As mentioned above, the training can be compute-optimal given the target model 132 and target data 134 sizes as defined by the allocation tuple [Nₜ, Dₜ] 130. In other words, the training consumes the allocated computing resources defined by the compute budget 112 and the performance of the machine learning model 102 may be optimized for the machine learning task 104 given the compute budget 112.

After being trained, the machine learning model 102 can be deployed for use in performing the machine learning task 104. For instance, the machine learning model 102 can be deployed in an environment that can enable users to provide requests for the machine learning model 102 to process specified model inputs to generate corresponding model outputs. Users can provide the requests, e.g., by way of a user interface or through an application programming interface (API). The requests can be transmitted from a user device (e.g., over a data communication network such as the internet) to one or more computers implementing the machine learning model 102, e.g., in a data center. The machine learning model 102 can process model inputs specified by user requests to generate corresponding model outputs and then transmit the model outputs to user devices (e.g., over a data communication network).

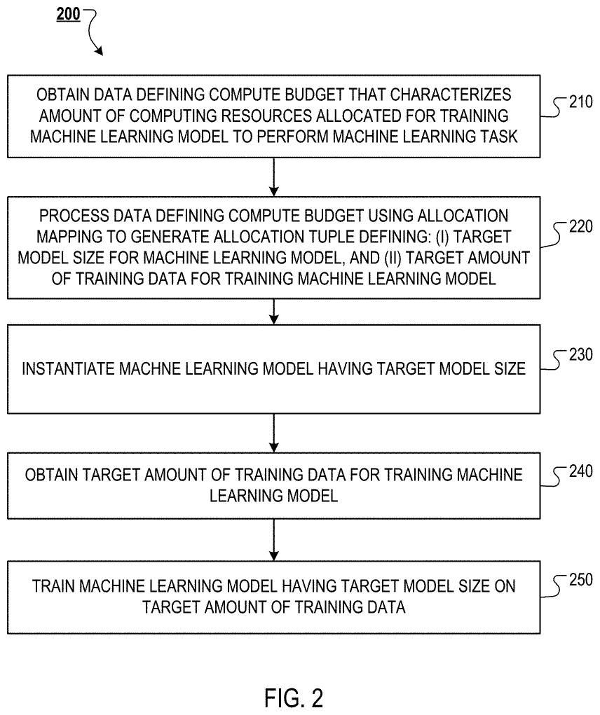

FIG. 2 is a flow diagram of an example process for training a machine learning model having a target model size on a target amount of training data to perform a machine learning task. For convenience, the process 200 will be described as being performed by a system of one or more computers located in one or more locations. For example, a training system, e.g., the training system 100 of FIG. 1, appropriately programmed in accordance with this specification, can perform the process 200.

Training system obtains data defining a compute budget that characterizes an amount of computing resources allocated for training a machine learning model to perform a machine learning task (210). The training system can obtain data defining the compute budget, e.g., from a user by way of a user interface or an application programming interface (API), or from an external resource management system, e.g., that manages computing resources in one or more data centers.

Training system processes the data defining the compute budget using an allocation mapping, in accordance with a set of allocation mapping parameters, to generate an allocation tuple defining: (i) a target model size for the machine learning model, and (ii) a target amount of training data for training the machine learning model (220). Training system generates the allocation tuple such that selecting a model size of the machine learning model as the target model size and training the machine learning model on the target amount of training data is predicted to optimize a performance of the machine learning model on the machine learning task subject to a constraint that an amount of computing resources used for training the machine learning model satisfies a threshold defined by the compute budget.

Training system instantiates the machine learning model, where the machine learning model has the target model size (230). For instance, training system can generate an instance of the machine learning model, including determining an architecture of the machine learning model and initializing values of a set of model parameters of the machine learning model. Training system can determine the architecture of the machine learning model, e.g., by mapping the target model size of the machine learning model to a corresponding machine learning model architecture (e.g., in accordance with a predefined architecture mapping). The architecture of the machine learning model can be defined, e.g., by a set of architectural hyper-parameters, and the system can generate the value of each architectural hyper-parameter as a function of the target model size. For example, in an implementation where the machine learning model is implemented as a neural network, the set of architectural hyper-parameters can include hyper-parameters that specify the number of layers in the neural network, the configuration of each layer in the neural network, and a directed graph that defines connectivity between the layers of the neural network. The training system can initialize the values of the set of model parameters of the machine learning model using any appropriate initialization technique, e.g., random initialization or Glorot initialization.

Training system obtains the target amount of training data for training the machine learning model (240). For example, to obtain the target amount of training data, the training system can access one or more data storage devices that store a corpus of training data. The system can identify a subset of the corpus of training data that includes the target amount of training data, e.g., by randomly sampling training data from the corpus of training data, and then retrieve the selected training data for use in training the machine learning model.

The training data for training the machine learning model can be generated in any of a variety of possible ways. For instance, the training data can include text sequences, e.g., that are scraped (e.g., extracted using systematic and automated techniques) from one or more data sources, e.g., one or more databases, or the internet. Training system can use text sequences for training the machine learning model to perform a language modeling task, as will be described in more detail below. As another example, the training data can include a set of training examples, where each training example includes: (i) a model input to the machine learning model (e.g., an image), and (ii) a target output (e.g., an image label), i.e., that should be generated by the machine learning model by processing the model input. Target outputs can be generated, e.g., through manual annotation, or in any other appropriate manner.

Training system trains the machine learning model having the target model size on the target amount of training data (250). The training system can train the machine learning model on the training data using any appropriate machine learning training technique. A few example techniques for training the machine learning model on a set of training data are described next.

In some implementations, the machine learning model is a neural network model, the set of training data includes a set of text sequences, and the training system trains the neural network to perform a language modeling task. In these implementations, for each text sequence, the training system can process (at least a portion of) the text sequence using the neural network to generate, for each of one or more positions in the text sequence, a score distribution over a set of possible tokens (e.g., textual tokens including characters, word pieces, words, n-grams, etc.). The neural network can be configured to generate a score distribution for a position in the text sequence by processing tokens from preceding positions in the text sequence, but not based on the token at the position or on tokens at subsequent positions in the text sequence. The training system can train the neural network based on an objective function that measures, for each of one or more positions in the text sequence, an error (e.g., a cross-entropy error) between: (i) the token at the position in the text sequence, and (ii) a score distribution over the set of possible tokens that is generated by the neural network for the position. Training the neural network based on the objective function can include, e.g., determining gradients of the objective function with respect to the parameters of the neural network (e.g., using backpropagation), and using the gradients to adjust the values of the parameters of the neural network (e.g., using the update rule of an appropriate gradient descent optimization technique such as RMSprop or Adam).

In some implementations, the training system trains the machine learning model to perform a supervised machine learning task. For example, training system can train the machine learning model on a set of training examples that each include: (i) a model input, (ii) a target output. Training the machine learning model on a training example can include training the machine learning model to process the model input of the training example to generate a predicted output that matches the target output of the training example. In particular, the training system can train the machine learning model to optimize an objective function that, for each training example, measures an error (e.g., a cross-entropy error or a squared error) between: (i) the target output of the training example, and (ii) the predicted output generated by the machine learning model for the training example.

FIG. 3 shows an example trial system 300 that can determine the values of the set of allocation mapping parameters 126 based on performance measures 350 of trial machine learning models 302. The trial system 300 is an example of a system implemented as computer programs on one or more computers in one or more locations in which the systems, components, and techniques described below are implemented.

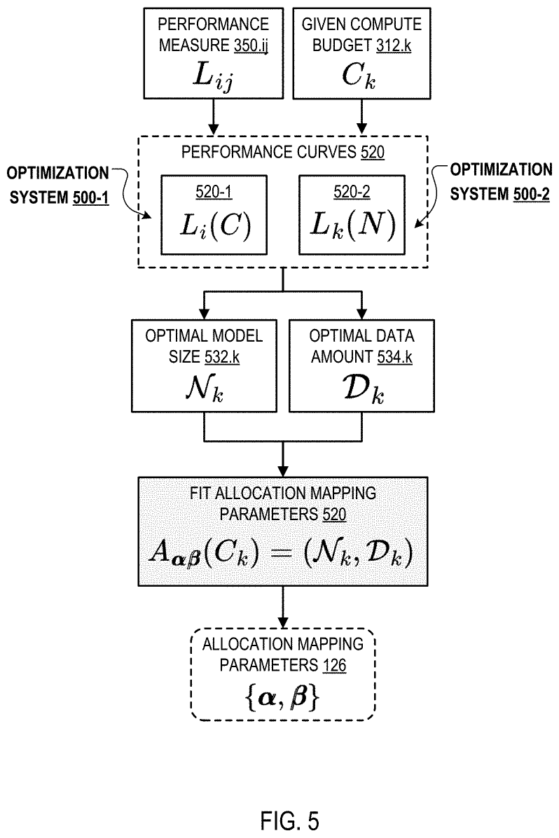

The trial system 300, in combination with an optimization system 500, can determine an allocation mapping 120 along with values of its mapping parameters 126. That is, given a particular machine learning model 102 and a particular machine learning task 104, trial system 300 can determine the corresponding allocation mapping 120 that provides the compute-optimal training of the model 102 for the task 104. Trial system 300 can accomplish this by empirically evaluating the performance of multiple trial machine learning models 302 with different trial model 332 and trial data 334 sizes. Optimization system 500 can then interpolate (and/or extrapolate) the performance of the trial sizes 332/334 to different possible sizes to determine the optimal sizes. From these results, optimization system 500 can determine the values of the mapping parameters 126. Three variations of optimization system 500 are described with respect to FIGS. 5-10 that utilize novel methods of specifying the values of the mapping parameters 126.

Trial system 300 can begin by identifying multiple trial allocation tuples 330. Each trial allocation tuple [Nᵢ, Dⱼ] 330.ij is a 2-tuple that defines a trial model size Nᵢ 332.i of the machine learning model 102 and a trial amount of training data Dⱼ 334.j for training the machine learning model 102. Trial system 300 can obtain the trial allocation tuples 330 in various ways. For example, trial system 300 can randomly sample trial model sizes Nᵢ and trial data sizes Dⱼ from a joint probability distribution [Nᵢ, Dⱼ]˜p(N,D), or sample them separately and generate trial allocation tuples 330.ij from various pairs of trial sizes 332.i/334.j. In other cases, the trial allocation tuples 330 may be specified by a user. Moreover, trial system 300 may choose the ranges and granularity in trial sizes based on a desired level of accuracy for the resultant mapping parameters 126. A larger range with more granularity may provide increased accuracy. For example, trial system 300 may use over four hundred trial allocation tuples 330 with trial model sizes 332 ranging from 70 M to 16 B parameters and trial data sizes 334 ranging from 5 B to over 400 B tokens. Note that a single trial model size 332.i can be associated with multiple different trial data sizes 334.j (and vice versa). This allows trial system 300 to gauge the performance of a trial machine learning model 302.ij having a particular trial model size 332.i on multiple different sized training sets 344.j. Along similar lines, a single trial model size 332.i is not necessarily associated with every trial data size 334.j (and vice versa). Hence, depending on the implementation, trial system 300 may or may not use every combination of Nᵢ and Dⱼ.

For each trial allocation tuple 330.ij, trial system 300 instantiates 142 a trial machine learning model 302.ij with the respective trial model size 332.i. Trial system 300 then trains the trial machine learning model 302.ij on a training data set 344.j having the respective trial amount of training data 334.j. As mentioned previously, trial system 300 can obtain the training data 344.j from the server 110 or other means. Trial system 300 can also determine the total compute Fᵢⱼ=F(Nᵢ, Dⱼ) of each trial machine learning model 302.ij that characterizes the amount of computing resources used during training of the trial machine learning model 302.ij. Hence, each trial allocation tuple [Nᵢ, Dⱼ] 330.ij provides a data point of the compute function F(N,D). In some implementations, trial system 300 trains the trial machine learning models 302.ij using learning rates that correspond to their trial data sizes 334.j. For example, trial system 300 can decay (decrease) the learning rate for larger trial data sizes 334.j.

Trial system 300 gauges the performance of each trial machine learning model 302.ij on the machine learning task 104 by determining a respective performance measure Lᵢⱼ=L(Nᵢ, Dⱼ) 350.ij. Hence, each trial allocation tuple [Nᵢ, Dⱼ] 330.ij also provides a data point of the performance function L(N,D). Trial system 300 then processes the performance measures Lᵢⱼ using the optimization system 500 to determine the values of the allocation mapping parameters 126. As mentioned above, three variations of the optimization system 500 are described with respect to FIGS. 5-11 that can each process the performance measures 350 different ways to determine the values of the mapping parameters 126.

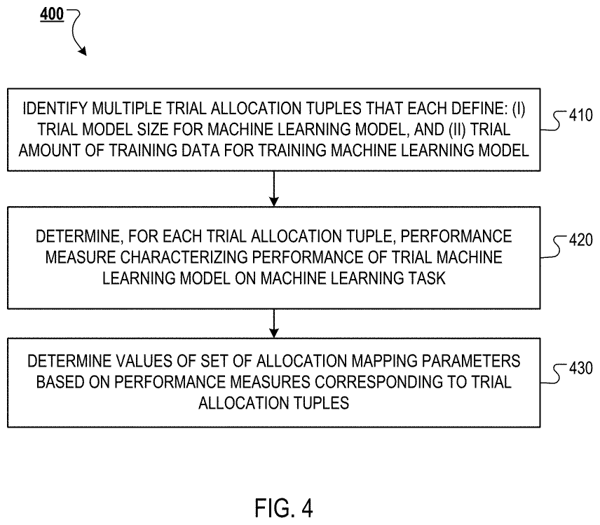

FIG. 4 is a flow diagram of an example process 400 for determining values of a set of allocation mapping parameters based on performance measures of trial machine learning models. For convenience, the process 400 will be described as being performed by a system of one or more computers located in one or more locations. For example, a trial system, e.g., the trial system 300 of FIG. 3, appropriately programmed in accordance with this specification, can perform the process 400.

Trial system identifies multiple trial allocation tuples, where each trial allocation tuple defines: (i) a trial model size for the machine learning model, and (ii) a trial amount of training data for training the machine learning model (410).

Trial system determines, for each of the multiple trial allocation tuples, a performance measure characterizing a performance of a trial machine learning model on the machine learning task resulting from selecting a model size of the trial machine learning model as the trial model size and training the trial machine learning model on the trial amount of training data (420).

Trial system determines the values of the set of allocation mapping parameters based on the performance measures corresponding to the multiple trial allocation tuples (430).

FIG. 5 shows two example optimization systems 500-1/500-2 that can determine the values of the set of allocation mapping parameters 126 based on performance curves 520. The optimization systems 500-1/500-2 are examples of systems implemented as computer programs on one or more computers in one or more locations in which the systems, components, and techniques described below are implemented.

Both first 500-1 and second 500-2 optimization systems determine the values of the mapping parameters 126 by first determining respective optimal model sizes 532 and optimal amounts of training data 534 for a given number of compute budgets 312. The optimal sizes 532/534 are compute-optimal for their respective compute budgets 312. The optimization systems 500-1/500-2 then interpolate (and/or extrapolate) these data points to fit the mapping parameters 126 of the allocation mapping 120, which establishes the continuous mapping from compute budgets 120 to allocation tuples 130. However, the two optimization systems 500-1/500-2 can differ in how they determine the optimal sizes 532/534 themselves. First optimization system 500-1 fixes trial model sizes 332 and generates curves by varying trial data sizes 334. Conversely, second optimization system 500-2 varies trial model sizes 332 and generates curves while fixing the total computes to the compute budgets 312 (i.e., “iso-compute-budget” curves). First 500-1 and second 500-2 optimization systems may work separately or in synergy to determine the values of the mapping parameters 126. For example, the results of two optimization systems 500-1/500-2 may be averaged, used for different types of machine learning models 102, used for different ranges of trial sizes, etc. Details of first optimization system 500-1 are outlined below followed by second optimization system 500-2.

First Optimization System (FOS)

FOS 500-1 determines a respective performance curve 522.i for each trial model size 332.i. A performance curve Lᵢ(C) for a trial model size Nᵢ defines a continuous mapping from possible compute budgets C to predicted performance measures Lᵢ. In this case, a predicted performance measure refers to a predicted performance of a trial machine learning model 302 having the trial model size Nᵢ when it is trained using a total compute F(Nᵢ,D) equal to the possible compute budget F(Nᵢ,D)=C. Analogously, the constraint F(Nᵢ,D)=C defines the equation of a curve from possible compute budgets C to possible amounts of training data D (and vice versa) given the trial model size Nᵢ.

FOS 500-1 can determine a performance curve 522.i for a trial model size 332.i by interpolating the performance measures Lit of trial allocation tuples 330.ij corresponding to the trial model size Nᵢ. In other words, FOS 500-1 interpolates the performance measures Lᵢⱼ against the trial data sizes Dⱼ associated with the trial model size Nᵢ. FOS 500-1 can use various different curve fitting techniques to interpolate the performance measures 350 such as power law fitting, linear regression, polynomial regression, polynomial interpolation, among others.

FOS 500-1 then determines an optimal model size [symbol] 532.k and an optimal amount of training data [symbol] ₖ 534.k for each given compute budget Cₖ 312.k. To do so, FOS 500-1 determines an optimal performance curve Lₖ(Cₖ) for each given compute budget Cₖ 312.k. The optimal performance curve achieves an optimal performance measure for the given compute budget 312.k. That is, it achieves the minimum value amongst all performance curves 522 when evaluated at Cₖ:

Lₖ(Cₖ)<L_{i≠k}(Cₖ)

FOS 500-1 then selects the associated trial model size [symbol] =Nₖ as the optimal model size 532.k for the given compute budget 312.k. FOS 500-1 can then determine the optimal data size 534.k from the optimal model size 532.k and the corresponding compute budget 312.k, e.g., using the constraint F( [symbol] , [symbol] ₖ)=Cₖ. In general, F(N,D) can be any appropriate function that characterizes the relationship between the model size N, amount of training data D, and the required compute F to train a machine learning model 102 having the model size on the amount of training data. For instance, in some implementations, the function is assumed or approximated as F(N,D)≈cND where c is a constant such as c=6. In other implementations, trial 300 and/or optimization 500 systems can determine F(N,D) empirically from the total computes Fᵢⱼ=F(Nᵢ, Dⱼ) expended during training the trial machine learning models 302, e.g., using interpolation and other data fitting techniques described herein.

FOS 500-1 then fits the values of the mapping parameters 126 using the optimal model sizes 532, the optimal data sizes 534, and the given compute budgets 312, e.g., to minimize an error between A_{αβ}(Cₖ)=[Nₜ(Cₖ), Dₜ(Cₖ)] and [ [symbol] , [symbol] ₖ] for each associated triplet of [symbol] , [symbol] ₖ and Cₖ. For example, FOS 500-1 can use any of the curve fitting techniques described herein to fit the values of the mapping parameters 126.

Second Optimization System (SOS)

SOS 500-2 determines a respective performance curve 524.k for each given compute budget 312.k. A performance curve Lₖ(N) for a compute budget Cₖ defines a continuous mapping from possible model sizes N to predicted performance measures Lₖ. In this case, a predicted performance measure refers to a predicted performance of a trial machine learning model 302 having a possible model size N when it is trained using a total compute F(N,D) equal to the given compute budget F(N,D)=Cₖ. Analogously, the constraint F(N,D)=Cₖ defines the equation of a curve from possible model sizes N to possible amounts of training data D (and vice versa) given the compute budget Cₖ. Hence, the performance curves 524 correspond to “iso-compute-budget” curves as the respective compute budget 312.k is fixed for each curve 524.k.

SOS 500-2 can determine a performance curve 524.k for a given compute budget 312.k by interpolating the performance measures Lᵢⱼ of trial allocation tuples 330.ij corresponding to the compute budget Cₖ. In other words, the SOS 500-2 interpolates the performance measures Lᵢⱼ against the trial model sizes Nᵢ, while choosing trial data sizes Dⱼ such that a total compute is fixed to the compute budget Fᵢⱼ=Cₖ. SOS 500-2 can use various different curve fitting techniques to interpolate the performance measures 350 such as power law fitting, linear regression, polynomial regression, polynomial interpolation, among others.

SOS 500-2 then determines an optimal model size Nₖ 532.k and an optimal amount of training data [symbol] ₖ 534.k for each compute budget Cₖ 312.k. To do so, SOS 500-2 selects the optimal model size 532.k as the model size that optimizes the respective performance curve 524.k of a given compute budget 312.k, such that [symbol] corresponds to a minimum.

SOS 500-2 can then determine the optimal data size 534.k from the optimal model size 532.k and the corresponding compute budget 312.k, e.g., using the constraint F(Nₖ, [symbol] ₖ)=Cₖ. As mentioned above with respect to FOS 500-1, SOS 500-2 can assume a functional form of F(N,D) or determine it empirically.

SOS 500-2 then fits the values of the mapping parameters 126 using the optimal model sizes 532, the optimal data sizes 534, and the given compute budgets 312, e.g., to minimize an error between A_{αβ}(Cₖ)=[Nₜ(Cₖ), Dₜ(Cₖ)] and [Nₖ, [symbol] ₖ] for each associated triplet of Nₖ, [symbol] ₖ and Cₖ. For example, SOS 500-2 can use any of the curve fitting techniques descried herein to fit the values of the mapping parameters 126.

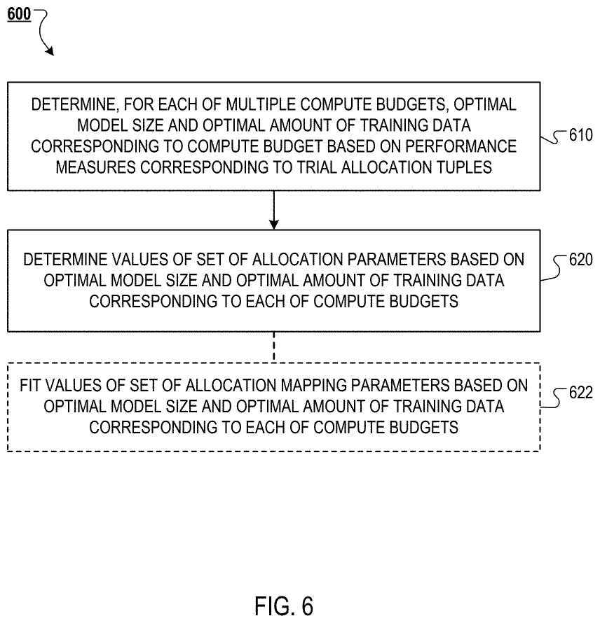

FIG. 6 is a flow diagram of an example process 600 for determining values of a set of allocation mapping parameters based on optimal model sizes and optimal amounts of training data for given compute budgets. For convenience, the process 600 will be described as being performed by a system of one or more computers located in one or more locations. For example, an optimization system, e.g., the optimization systems 500-1 and 500-2 of FIG. 5, appropriately programmed in accordance with this specification, can perform the process 600.

Optimization system determines, for each of multiple compute budgets, an optimal model size and an optimal amount of training data corresponding to the compute budget based on performance measures corresponding to multiple trial allocation tuples (610).

Optimization system determines the values of the set of allocation mapping parameters based on the optimal model size and the optimal amount of training data corresponding to each of the multiple compute budgets (620).

In some implementations, step 620 is accomplished by step 622 which proceeds as follows:

Optimization system fits the values of the set of allocation mapping parameters based on the optimal model size and the optimal amount of training data corresponding to each of the multiple compute budgets (622).

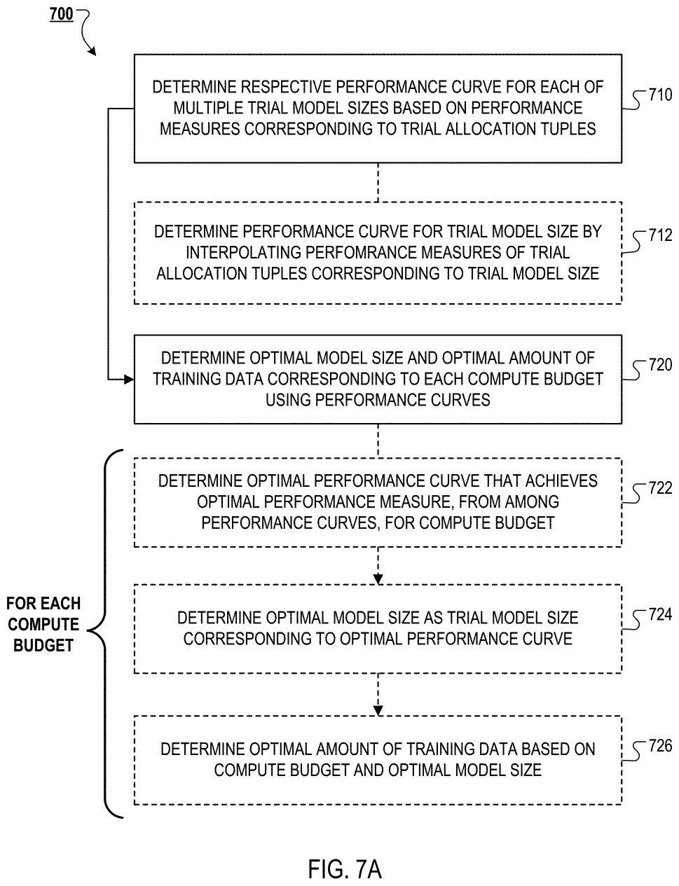

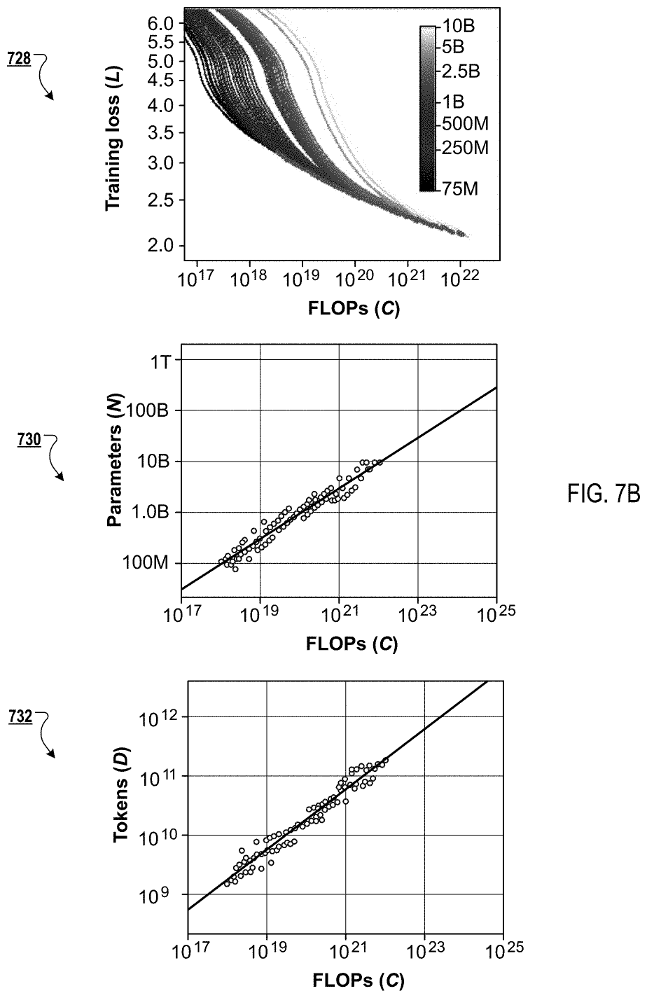

FIG. 7A is a flow diagram of an example process 700 for determining optimal model sizes and optimal amounts of training data for given compute budgets based on performance curves. For convenience, the process 700 will be described as being performed by a system of one or more computers located in one or more locations. For example, an optimization system, e.g., the first optimization system 500-1 of FIG. 6, appropriately programmed in accordance with this specification, can perform the process 700.

Optimization system determines a respective performance curve for each of multiple trial model sizes based on the performance measures corresponding to multiple trial allocation tuples (710). A performance curve for a trial model size defines a continuous mapping from possible compute budgets to predicted performance measures, where a predicted performance measure corresponding to a possible compute budget defines a predicted performance of a trial machine learning model with the trial model size that is trained using an amount of computing resources that satisfies a threshold defined by the possible compute budget.

In some implementations, step 710 is accomplished by step 712 which proceeds as follows:

Optimization system determines a performance curve for a trial model size by interpolating the performance measures of trial allocation tuples corresponding to the trial model size (712).

Optimization system determines the optimal model size and the optimal amount of training data corresponding to each compute budget using the performance curves (720).

In some implementations, step 720 is accomplished by steps 722-726 which proceeds as follows. For each compute budget of the multiple compute budgets:

Optimization system determines an optimal performance curve that achieves an optimal performance measure, from among the performance curves, for the compute budget (722).

Optimization system determines the optimal model size as the trial model size corresponding to the optimal performance curve (724).

Optimization system determines the optimal amount of training data based on the compute budget and the optimal model size (726).

FIG. 7B shows an example of generating a set of allocation mapping parameters using performance curves that define continuous mappings from possible compute budgets to predicted performance measures. In particular, graph 728 shows an example of performance curves mapping possible compute budgets to predicted performance measures that the system generates by training a range of trial model sizes from 75 million to 10 billion parameters. In the graph 728, the horizontal axis represents possible compute budgets and the vertical axis represents predicted performance measures which in this case is characterized as a training loss, e.g., such that a lower training loss represents better performance. The system determines the optimal performance curve, e.g., by determining, for each compute budget, the performance curve representing the best performance measure for the compute budget (in this case the lowest value for the compute budget). The system then uses the optimal performance curves to generate allocation mapping parameters defining a mapping from possible compute budgets to target model sizes (represented by a line in graph 730) and defining a mapping from possible compute budgets to target amounts of training data (represented by a line in graph 732). Particularly, the data points in graph 730 correspond to pairs of [symbol] vs. Cₖ which is used to fit Nₜ (C) that is represented by the line in graph 730. Analogously, the data points in graph 732 correspond to pairs of [symbol] ₖ vs. Cₖ which is used to fit Dₜ(C) that is represented by the line in graph 732. This fitting then determines the appropriate allocation mapping A_{αβ}(C)=[Nₜ(C), Dₜ(C)].

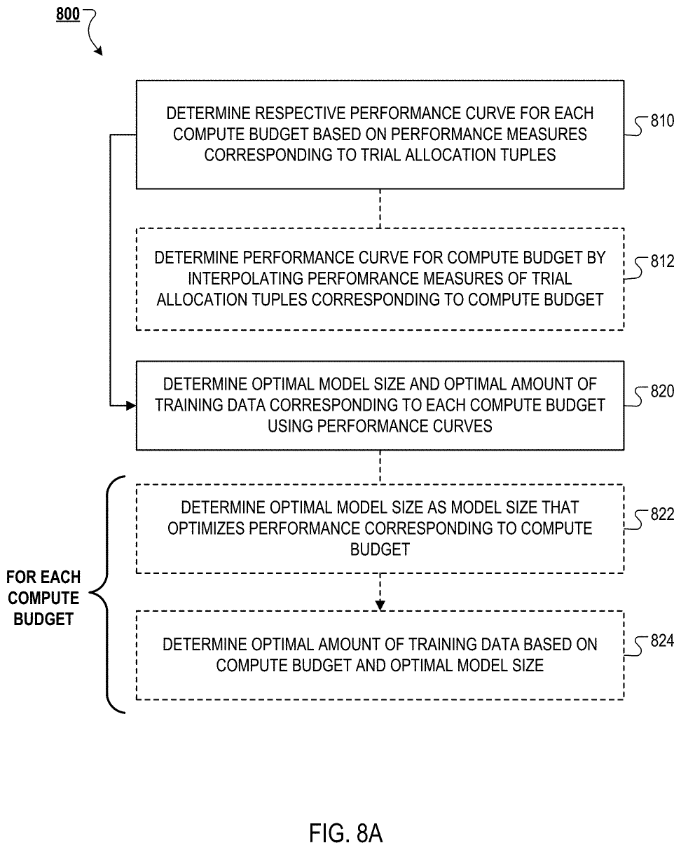

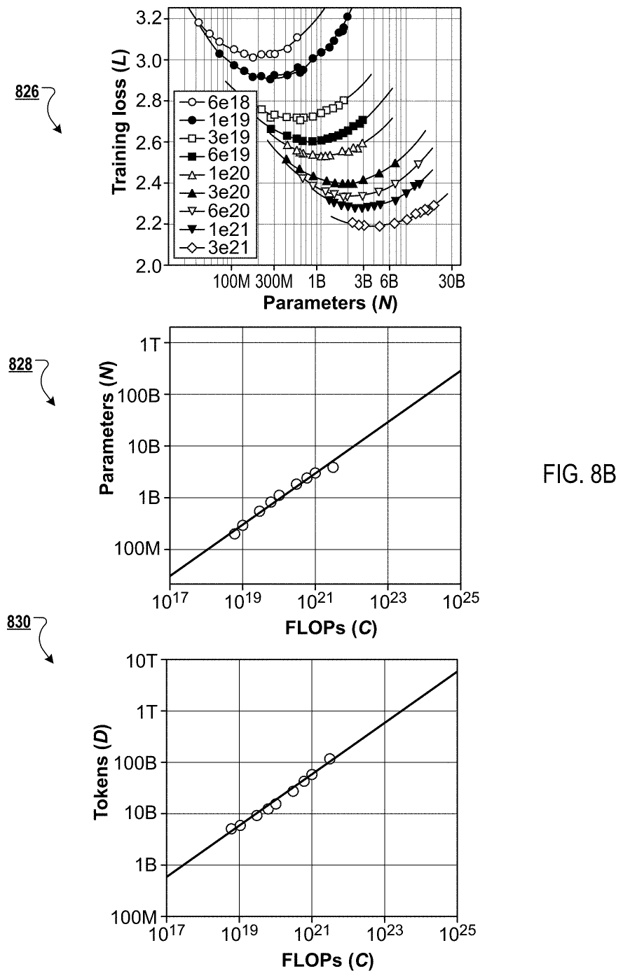

FIG. 8A is a flow diagram of another example process 800 for determining optimal model sizes and optimal amounts of training data for given compute budgets based on performance curves. For convenience, the process 800 will be described as being performed by a system of one or more computers located in one or more locations. For example, an optimization system, e.g., the second optimization system 500-2 of FIG. 6, appropriately programmed in accordance with this specification, can perform the process 800.

Optimization system determines a respective performance curve for each of multiple compute budgets based on performances measures corresponding to multiple trial allocation tuples (810). A performance curve for a compute budget defines a continuous mapping from possible model sizes to predicted performance measures, where a predicted performance measure corresponding to a possible model size defines a predicted performance of a trial machine learning model with the possible model size that is trained using an amount of computing resources that satisfies a threshold defined by the compute budget.

In some implementations, step 810 is accomplished by step 812 which proceeds as follows. Optimization system determines a performance curve for a compute budget by interpolating performance measures of trial allocation tuples corresponding to the compute budget, where a trial allocation tuple corresponds to the compute budget if training a trial machine learning model with the trial model size defined by the trial allocation tuple on the trial amount of training data defined by the trial allocation tuple would use an amount of computing resources that satisfies a threshold defined by the compute budget.

Optimization system determines the optimal model size and the optimal amount of training data corresponding to each compute budget using the performance curves (820).

In some implementations, step 820 is accomplished by steps 822 and 824 which proceeds as follows: For each compute budget of the multiple compute budgets:

Optimization system determines the optimal model size as a model size that optimizes the performance curve corresponding to the compute budget (822).

Optimization system determines the optimal amount of training data based on the compute budget and the optimal model size (824).

FIG. 8B shows an example of generating a set of allocation mapping parameters using a respective performance curve for each of multiple possible compute budgets. A performance curve for a compute budget defines a continuous mapping from possible model sizes to predicted performance measures, where the amount of training data used during training is selected to cause the total compute used during training to match the compute budget. In this case, the compute budgets are selected in a range of 6×10¹⁸ to 3×10²¹ FLOPs. In particular, in the graph 826, the horizontal axis represents possible model sizes and the vertical axis represents predicted performance measures which in this case is characterized by a training loss (e.g., such that a lower training loss represents better performance). The system then uses the performance curves to generate allocation mapping parameters defining a mapping from possible compute budgets to target model sizes (represented as a line in graph 828) and defining a mapping from possible compute budgets to target amounts of training data (represented as a line in graph 830). Particularly, the data points in graph 828 correspond to pairs of [symbol] vs. Cₖ which is used to fit Nₜ(C) that is represented by the line in graph 828. Analogously, the data points in graph 830 correspond to pairs of [symbol] ₖ vs. Cₖ which is used to fit Dₜ(C) that is represented by the line in graph 830. This fitting then determines the appropriate allocation mapping A_{αβ}(C)=[Nₜ(C), Dₜ(C)].

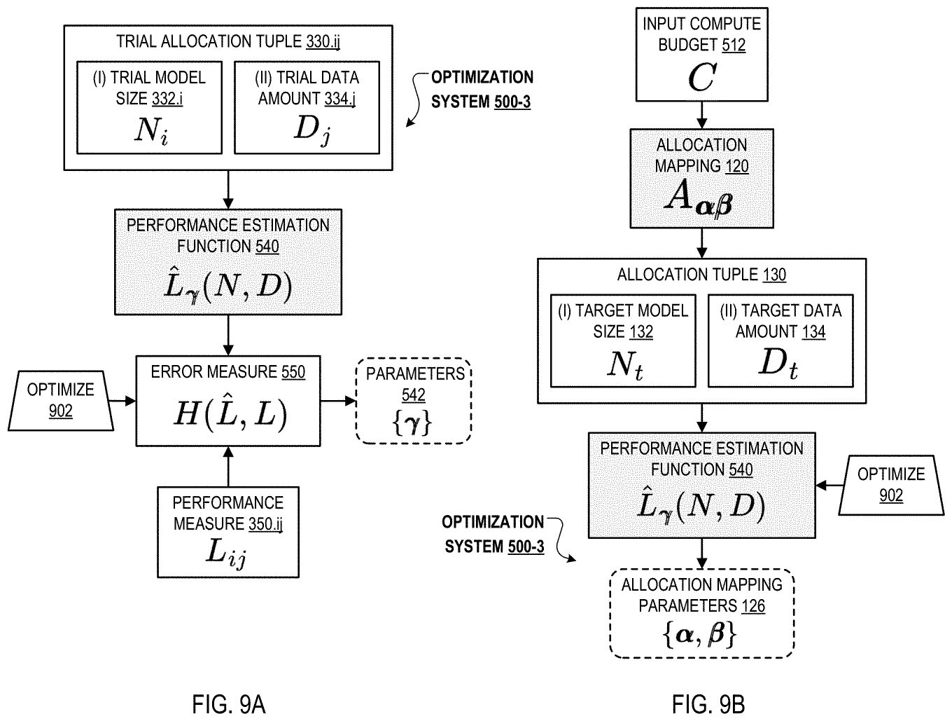

FIGS. 9A and 9B shows an example optimization system 500-3 that can determine values of a set of allocation mapping parameters 126 using a performance estimation function 540. The optimization system 500-3 is an example of a system implemented as computer programs on one or more computers in one or more locations in which the systems, components, and techniques described below are implemented.

Third Optimization System (TOS)

TOS 500-3 uses a different approach compared to FOS 500-1 and SOS 500-2. Instead of generating performance curves, TOS 500-3 estimates the performance function L(N,D) directly using the performance estimation function \hat{L}_{γ}(N,D) 540. The performance estimation function 540 is configured to process data defining an input model size N and an input amount of training data D to generate a predicted performance measure. The predicted performance measure characterizes a predicted performance of the machine learning model 102 on the machine learning task 104, given that the machine learning model 102 has the input model size N and is trained on the input amount of training data D. Similar to the mapping parameters 126 of the allocation mapping 120, the performance estimation function 540 is parametrized by a set of parameters {γ} 542 that dictate its functional form. In some implementations, e.g., when the machine learning model 102 is a LLM, the performance estimation function 540 may be approximated as:

$${\hat{L}}_{γ} ( N , D ) = E + \frac{A}{{N}^{α}} + \frac{B}{{D}^{β}} \qquad ( ★ )$$

In this case, {γ}={E, A, B, α, β} is the set of parameters 542 of the performance estimation function 540 that determine the functional dependence of \hat{L}_{γ} on N and D. The first term of equation (*) captures the loss for an ideal generative process on a data distribution. The second term takes into account that a machine learning model having a model size N underperforms the ideal generative process. The final term takes into account the machine learning model not being trained to convergence.

Referring to FIG. 9A, TOS 500-3 first determines the values of the parameters 542 by comparing the performance measures Lᵢⱼ 350 of the trial allocation tuples 330 to the predicted performance measures generated by the performance estimation function 540. Particularly, TOS 500-3 processes the trial model size 332.i and the trial data size 334.j of each trial allocation tuple 330.ij using the performance estimation function 540 to generate a corresponding predicted performance measure \hat{L}_{γ}(Nᵢ, Dⱼ). TOS 500-3 then uses an error measure H 550 to compare the differences between the observed and predicted performance measures:

$${H}_{γ} = {\sum }_{ij} H [ {\hat{L}}_{γ} ( {N}_{i} , {D}_{j} ) , {L}_{ij} ]$$

In some implementations, the error measure 550 is a Huber loss which corresponds to:

$${H}_{γ} = {\sum }_{ij} {Huber}_{δ} [ log {\hat{L}}_{γ} ( {N}_{i} , {D}_{j} ) - log {L}_{ij} ]$$

The Huber loss (δ=10⁻³) is generally robust to outliers which makes it well-suited for predictive performance.

TOS 500-3 then optimizes 902 the error measure 500 with respect to the performance estimation function 540's parameters γ 542 to determine their respective values.

Referring to FIG. 9B, TOS 500-3 substitutes the unknown performance function L(N,D) for the known performance estimation function \hat{L}_{γ}(N,D). TOS 500-3 then determines the values of the mapping parameters 126 such that the target model size Nₜ 132 and the target data size Dₜ 134 optimize the performance estimation function \hat{L}_{γ}(N,D) for each input compute budget 512 to the allocation mapping [Nₜ(C), Dₜ(C)]=A_{αβ}(C) 120. In other words, the target sizes 132/134 correspond to extrema of the performance estimation function 550 for each input compute budget 512:

$${N}_{t} ( C ) , {D}_{t} ( C ) = {arg min {\hat{L}}_{γ} ( N , D )}_{N , D s . t . F ( N , D ) = C}$$

Note that the above equation is subject to the constraint that the total compute F(Nₜ, Dₜ)=C equals the input compute budget 512. TOS 500-3 may implement a compute function of the form F(N,D)≈6ND which allows TOS 500-3 to estimate the values of the mapping parameters 126. However, as mentioned with respect to FOS 500-1 and SOS 500-2, TOS 500-3 may determine F(N,D) empirically (e.g., by interpolation) using the total computes Fᵢⱼ expended during training of the trial machine learning models 302.ij. Using F(N,D)≈6ND, TOS 500-3 can estimate the values of the mapping parameters 126 as:

$$[ {N}_{t} ( C ) , {D}_{t} ( C ) ] = [ {G ( \frac{C}{6} )}^{a} , {{G}^{- 1} ( \frac{C}{6} )}^{b} ] , G = {( \frac{α A}{β B} )}^{\frac{1}{α + β}} ,$$

$$a = \frac{β}{α + β} , b = \frac{α}{α + β}$$

where Nₜ(C) denotes the target model size given compute budget C and Dₜ(C) denotes the target amount of training data given the compute budget C. In this case, {α,β}={E, A, B, α, β} are allocation mapping parameters 126 of the allocation mapping 120 described with reference to equation (*) and correspond to the same parameters 542 of the performance estimation function 540, but determine the functional dependence of Nₜ and Dₜ on C.

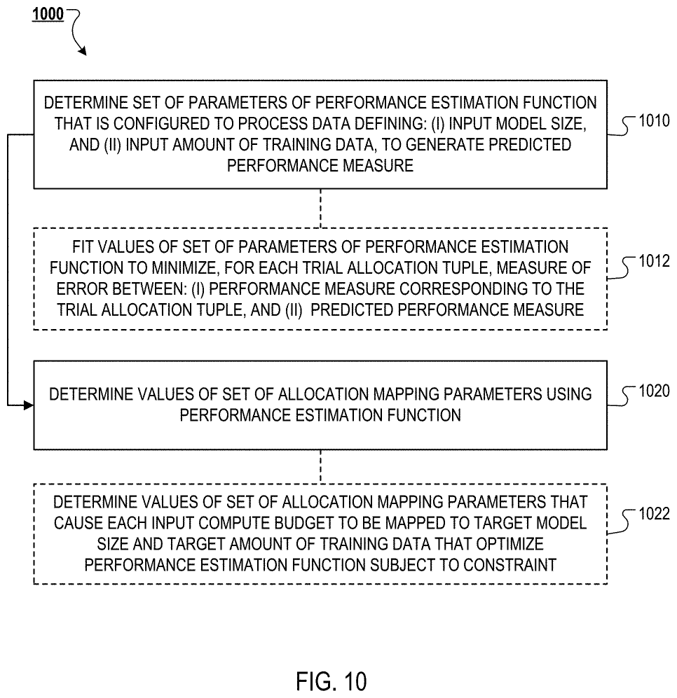

FIG. 10 is a flow diagram of an example process 1000 for determining values of a set of allocation mapping parameters using a performance estimation function. For convenience, the process 1000 will be described as being performed by a system of one or more computers located in one or more locations. For example, an optimization system, e.g., the third optimization system 500-3 of FIG. 9A, appropriately programmed in accordance with this specification, can perform the process 1000.

Optimization system determines a set of parameters of a performance estimation function that is configured to process data defining: (i) an input model size, and (ii) an input amount of training data, to generate a predicted performance measure that characterizes a predicted performance of a machine learning model having the input model size, that is trained on the input amount of training data, on the machine learning task (1010). Optimization system fits values of the set of parameters of the performance estimation function based on performance measures corresponding to multiple trial allocation tuples.

In some implementations, step 1010 is accomplished by step 1012 which proceeds as follows:

Optimization system fits the values of the set of parameters of the performance estimation function to minimize, for each trial allocation tuple, a measure of error between: (i) the performance measure corresponding to the trial allocation tuple, and (ii) a predicted performance measure generated by processing the trial model size and the trial amount of training data defined by the trial allocation tuple using the performance estimation function (1012).

Optimization system determines the values of the set of allocation mapping parameters using the performance estimation function (1020).

In some implementations, step 1020 is accomplished by step 1022 which proceeds as follows:

Optimization system determines the values of the set of allocation mapping parameters to cause each input compute budget to be mapped to a target model size and a target amount of training data that optimize the performance estimation function subject to a constraint that training a machine learning model having the target model size on the target amount of training data uses an amount of computing resources given by the input compute budget (1022).

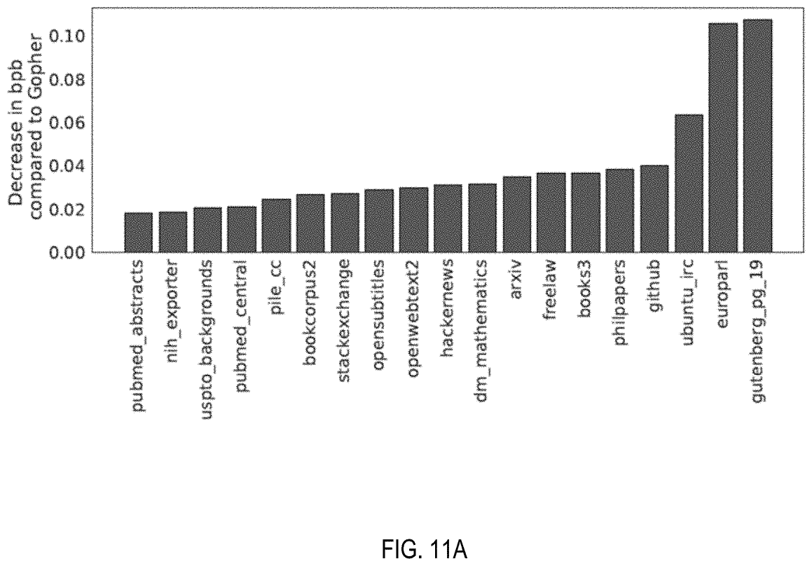

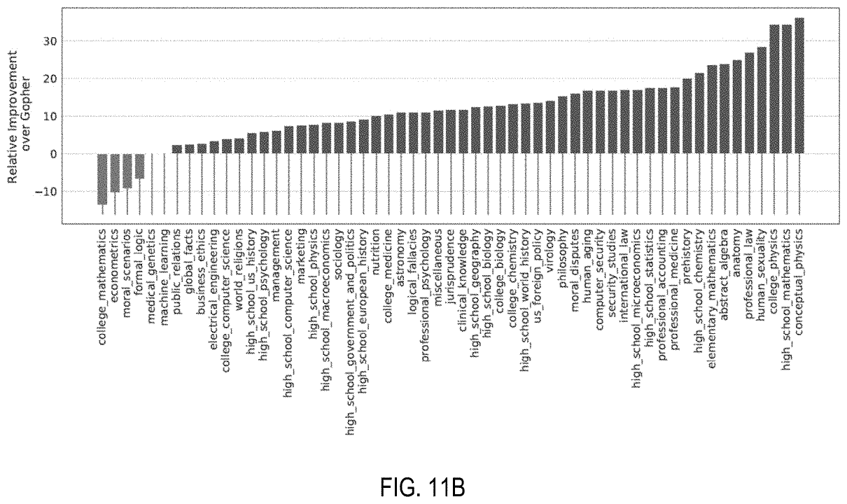

FIGS. 11A and 11B show examples of experimental results that compare the performance of: (i) a “compute-optimal” machine learning model that is generated by the training system 300 described in this specification, and (ii) an alternative machine learning model (“Gopher”). The compute-optimal machine learning model requires the same compute budget during training as the alternative machine learning model, but has 4 times fewer model parameters and is trained on 4 times more training data. FIG. 11A shows the improvement (measured in bits-per-byte) of the compute-optimal machine learning model as compared to the alternative machine learning model on a set of language modeling tasks. FIG. 11B shows the relative improvement (expressed in percent) of the compute-optimal machine learning model as compared to the alternative machine learning model on a set of language understanding tasks. It will be appreciated that the compute-optimal model generated by the training system 300 described in this specification significantly outperforms the alternative model.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining data defining a compute budget that characterizes an amount of computing resources allocated for training a machine learning model to perform a machine learning task;
processing the data defining the compute budget using an allocation mapping, in accordance with a set of allocation mapping parameters, to generate an allocation tuple defining: (i) a target model size for the machine learning model, and (ii) a target amount of training data for training the machine learning model,
wherein selecting a model size of the machine learning model as the target model size and training the machine learning model on the target amount of training data is predicted to optimize a performance of the machine learning model on the machine learning task subject to a constraint that an amount of computing resources used for training the machine learning model satisfies a threshold defined by the compute budget;
instantiating the machine learning model, wherein the machine learning model has the target model size;
obtaining the target amount of training data for training the machine learning model; and
training the machine learning model having the target model size on the target amount of training data.

2. The method of claim 1, wherein values of the set of allocation mapping parameters are determined by operations comprising:
identifying a plurality of trial allocation tuples, wherein each trial allocation tuple defines: (i) a trial model size for the machine learning model, and (ii) a trial amount of training data for training the machine learning model;
determining, for each of the plurality of trial allocation tuples, a performance measure characterizing a performance of a trial machine learning model on the machine learning task resulting from selecting a model size of the trial machine learning model as the trial model size and training the trial machine learning model on the trial amount of training data; and
determining the values of the set of allocation mapping parameters based on the performance measures corresponding to the plurality of trial allocation tuples.

3. The method of claim 2, determining the values of the set of allocation mapping parameters based on the performance measures corresponding to the plurality of trial allocation tuples comprises:
determining, for each of a plurality of compute budgets, an optimal model size and an optimal amount of training data corresponding to the compute budget based on the performance measures corresponding to the plurality of trial allocation tuples; and
determining the values of the set of allocation mapping parameters based on the optimal model size and the optimal amount of training data corresponding to each of the plurality of compute budgets.

4. The method of claim 3, wherein determining the values of the set of allocation mapping parameters based on the optimal model size and the optimal amount of training data corresponding to each of the plurality of compute budgets comprises:
fitting the values of the set of allocation mapping parameters based on the optimal model size and the optimal amount of training data corresponding to each of the plurality of compute budgets.

5. The method of claim 3, wherein determining, for each of the plurality of compute budgets, the optimal model size and the optimal amount of training data corresponding to the compute budget comprises:
determining a respective performance curve for each of a plurality of trial model sizes based on the performance measures corresponding to the plurality of trial allocation tuples,
wherein a performance curve for a trial model size defines a continuous mapping from possible compute budgets to predicted performance measures, wherein a predicted performance measure corresponding to a possible compute budget defines a predicted performance of a trial machine learning model with the trial model size that is trained using an amount of computing resources that satisfies a threshold defined by the possible compute budget; and
determining the optimal model size and the optimal amount of training data corresponding to each compute budget using the performance curves.

6. The method of claim 5, wherein determining a performance curve for a trial model size comprises:
determining the performance curve for the trial model size by interpolating the performance measures of trial allocation tuples corresponding to the trial model size.

7. The method of claim 5, wherein determining the optimal model size and the optimal amount of training data corresponding to each compute budget using the performance curves comprises, for each compute budget of the plurality of compute budgets:
determining an optimal performance curve that achieves an optimal performance measure, from among the performance curves, for the compute budget;
determining the optimal model size as the trial model size corresponding to the optimal performance curve; and
determining the optimal amount of training data based on the compute budget and the optimal model size.

8. The method of claim 3, wherein determining, for each of the plurality of compute budgets, the optimal model size and the optimal amount of training data corresponding to the compute budget comprises:
determining a respective performance curve for each of the plurality of compute budgets based on the performances measures corresponding to the plurality of trial allocation tuples,
wherein a performance curve for a compute budget defines a continuous mapping from possible model sizes to predicted performance measures, wherein a predicted performance measure corresponding to a possible model size defines a predicted performance of a trial machine learning model with the possible model size that is trained using an amount of computing resources that satisfies a threshold defined by the compute budget; and
determining the optimal model size and the optimal amount of training data corresponding to each compute budget using the performance curves.

9. The method of claim 8, wherein determining a performance curve for a compute budget comprises:
determining the performance curve for the compute budget by interpolating performance measures of trial allocation tuples corresponding to the compute budget,
wherein a trial allocation tuple corresponds to the compute budget if training a trial machine learning model with the trial model size defined by the trial allocation tuple on the trial amount of training data defined by the trial allocation tuple would use an amount of computing resources that satisfies a threshold defined by the compute budget.

10. The method of claim 8, wherein determining the optimal model size and the optimal amount of training data corresponding to each compute budget using the performance curves comprises, for each compute budget of the plurality of compute budgets:
determining the optimal model size as a model size that optimizes the performance curve corresponding to the compute budget; and
determining the optimal amount of training data based on the compute budget and the optimal model size.

11. The method of claim 2, wherein determining the values of the set of allocation mapping parameters based on the performance measures corresponding to the plurality of trial allocation tuples comprises:
determining a set of parameters of a performance estimation function that is configured to process data defining: (i) an input model size, and (ii) an input amount of training data, to generate a predicted performance measure that characterizes a predicted performance of a machine learning model having the input model size, that is trained on the input amount of training data, on the machine learning task, comprising:
fitting values of the set of parameters of the performance estimation function based on the performance measures corresponding to the plurality of trial allocation tuples; and
determining the values of the set of allocation mapping parameters using the performance estimation function.

12. The method of claim 11, wherein determining the values of the set of allocation mapping parameters using the performance estimation function comprises:
determining the values of the set of allocation mapping parameters to cause each input compute budget to be mapped to a target model size and a target amount of training data that optimize the performance estimation function subject to a constraint that training a machine learning model having the target model size on the target amount of training data uses an amount of computing resources given by the input compute budget.

13. The method of claim 11, wherein fitting the values of the set of parameters of the performance estimation function based on the performance measures corresponding to the plurality of trial allocation tuples comprises:
fitting the values of the set of parameters of the performance estimation function to minimize, for each trial allocation tuple, a measure of error between: (i) the performance measure corresponding to the trial allocation tuple, and (ii) a predicted performance measure generated by processing the trial model size and the trial amount of training data defined by the trial allocation tuple using the performance estimation function.

14. The method of claim 13, wherein the measure of error comprises a Huber loss.

15. The method of claim 2, wherein for each of the plurality of trial allocation tuples, determining the performance measure corresponding to the trial allocation tuple comprises:
training a trial machine learning model having the trial model size on the trial amount of training data using a learning rate schedule that is selected based on the trial amount of training data.

16. The method of claim 1, wherein the allocation mapping causes the target model size and the target amount of training data to increase at substantially a same rate in response to an increase in the compute budget.

17. The method of claim 1, wherein the machine learning task comprises a language modeling task.

18. The method of claim 1, wherein the machine learning model comprises a neural network model.

19. One or more non-transitory computer storage media storing instructions that when executed by one or more computers cause the one or more computers to perform operations comprising:
obtaining data defining a compute budget that characterizes an amount of computing resources allocated for training a machine learning model to perform a machine learning task;
processing the data defining the compute budget using an allocation mapping, in accordance with a set of allocation mapping parameters, to generate an allocation tuple defining: (i) a target model size for the machine learning model, and (ii) a target amount of training data for training the machine learning model,
wherein selecting a model size of the machine learning model as the target model size and training the machine learning model on the target amount of training data is predicted to optimize a performance of the machine learning model on the machine learning task subject to a constraint that an amount of computing resources used for training the machine learning model satisfies a threshold defined by the compute budget;
instantiating the machine learning model, wherein the machine learning model has the target model size;
obtaining the target amount of training data for training the machine learning model; and
training the machine learning model having the target model size on the target amount of training data.

20. A system comprising:
one or more computers; and
one or more storage devices communicatively coupled to the one or more computers, wherein the one or more storage devices store instructions that, when executed by the one or more computers, cause the one or more computers to perform operations comprising:
obtaining data defining a compute budget that characterizes an amount of computing resources allocated for training a machine learning model to perform a machine learning task;
processing the data defining the compute budget using an allocation mapping, in accordance with a set of allocation mapping parameters, to generate an allocation tuple defining: (i) a target model size for the machine learning model, and (ii) a target amount of training data for training the machine learning model,
wherein selecting a model size of the machine learning model as the target model size and training the machine learning model on the target amount of training data is predicted to optimize a performance of the machine learning model on the machine learning task subject to a constraint that an amount of computing resources used for training the machine learning model satisfies a threshold defined by the compute budget;
instantiating the machine learning model, wherein the machine learning model has the target model size;
obtaining the target amount of training data for training the machine learning model; and
training the machine learning model having the target model size on the target amount of training data.
